(19) United States
(12) Patent Application Publication
(10) Pub. No.: US 2008/0039431 A1
(43) Pub. Date: Feb. 14, 2008

(54) Method of improving plant growth by reducing viral infections

(76) Inventors: Charles L. Cleary, Tifton, GA (US); Richard D. Rudolph, Molion, FL (US); John E. Curtis, Cantonment, FL (US); George H. Musson, Research Triangle Park, NC (US)

Correspondence Address: BAYER CROPSCIENCE LP, Patent Department, 2 T .W. ALEXANDER DRIVE, RESEARCH TRIANGLE PARK, NC, 27709, US

(21) Appl. No.: 11/888,540

(22) Filed: Aug. 1, 2007

Related U.S. Application Data
(60) Provisional application No. 60/836,355, filed on Aug. 8, 2006.

(51) Int. Cl. A01N 43/647; A01N 37/18; A01N 43/653; A01N 43/82; A01N 57/12; A01P 3/00; A01P 1/00; A01N 57/00; A01N 43/78; A01N 43/40

(52) U.S. Cl. 514/120; 514/229.2; 514/341; 514/342; 514/357; 514/362; 514/365; 514/383; 514/384; 514/626; 514/646; 514/75

(57) ABSTRACT

A method of improving the growth of a plant is provided by reducing the incidence of one or more insect-vectored viral infections. The method comprises the step of applying a primary treatment composition in-furrow during planting of a seed or seedling or during transplanting of the plant, wherein the primary treatment composition comprises an effective amount of a fungicide such as prothioconazole.

### FIELD OF THE INVENTION

The present invention is directed to methods of improving plant growth by reducing the incidence of insect-vectored viral infections.

### BACKGROUND OF THE INVENTION

Problems with insect-vectored viral diseases in plants such as commercial crops are well known and documented. There is a serious problem with yield loss due to the lack of effective disease prevention or control measures. For example, all attempts to provide relief from the problems of tomato spotted wilt virus (TSWV) have been only partially successful. TSWV is a major cause of yield losses in peanuts in the Southeast. Many growers use an extension service developed risk management guide called the “University of Georgia Tomato Spotted Wilt Risk Index for Peanuts”, which advises them of their risks when they use certain cultural practices. Guides such as this direct the grower to use an integrated approach to manage the virus. Guides take into account most significant factors affecting TSWV incidence, such as: cultivar susceptibility, planting date, seeding rate, insecticide use at planting, row pattern, and tillage type (strip or conventional). Additionally, uniform stands are thought to decrease TSWV. Peanuts are often planted in May as opposed to mid-April because the warmer soil temperatures allow the peanuts to grow faster and more uniformly. It is generally accepted that the faster the ground is covered with plant growth, the better for reducing TSWV. It is also known that certain herbicides can increase the incidence and/or severity of TSWV. Each measure taken to control TSWV makes a small contribution to reducing the severity and impact of the problem, but none are completely effective, even when used in combination. Moreover, no effective chemical treatment is known for the control of viral infections.

It would be desirable to develop an effective chemical treatment method for the reduction of the incidence of insect-vectored viral infections that stunt plant development or kill plants. An effective chemical treatment would overcome the inadequacies of the known control measures and improve plant growth through faster emergence, greater crop yields, higher protein content, more developed root systems, tillering increases, increases in plant height, bigger leaf blades, fewer dead basal leaves, stronger tillers, greener leaf color, earlier flowering, early grain maturity, increased shoot growth, improved plant vigor, and/or early germination.

### SUMMARY OF THE INVENTION

A method of improving the growth of a plant is provided. Plant growth is improved by reducing the incidence of one or more insect-vectored viral infections. The method comprises the step of applying a primary treatment composition in-furrow during planting of a seed or seedling, and/or or over the plant at or near emergence, and/or during transplanting of the plant, wherein the primary treatment composition comprises an effective amount of a fungicide. In additional embodiments of the present invention, the method comprises step(s) of applying one or more secondary and/or preliminary treatments in addition to the primary treatment. A particularly preferred group of fungicides for use in accordance with the present invention are the triazoles, and a particularly preferred triazole is prothioconazole.

### DETAILED DESCRIPTION OF THE INVENTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of 1″ to 10″ is intended to include all sub-ranges between and including the recited minimum value of 1 and the recited maximum value of 10, that is, having a minimum value equal to or greater than 1 and a maximum value of equal to or less than 10.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa; e. g., the singular forms “a,” “an,” and “the” include plural referents unless expressly and unequivocally limited to one referent.

With respect to the present invention, the phrase “effective amount” as used herein is intended to refer to an amount of an ingredient used such that a noticeable reduction in the effects caused by insect-vectored viral infections is observed in plants treated using the method of the present invention, compared to plants that did not receive treatment.

The method of the present invention comprises the step of applying a primary treatment composition in-furrow during planting of a seed or seedling or during transplanting of the plant, wherein the primary treatment composition comprises an effective amount of a fungicide such as prothioconazole. The composition is applied during planting; i. e., immediately prior to, concomitant with, or immediately following planting or transplanting, usually before row closure.

The method of the present invention improves plant growth by reducing the incidence of one or more insect-vectored viral infections, for example, those vectored by whitefly, aphid, leafhopper, and/or thrips. Such viruses include, inter alia, tomato spotted wilt virus (TSWV), tomato yellow leaf curl virus, and barley yellow dwarf virus. Plants that may be treated using the method of the present invention include but are not limited to flowering and ornamental plants and shrubs as well as crops. Crops which can be treated using the present method include but are not limited to grains, such as wheat, barley, rye, oats, rice, corn and sorghum; beet, such as sugar beet and fodder beet; fruit, such as apples, pears, plums, peaches, tomatoes, almonds, cherries and berries, including strawberries, raspberries and blackberries; citrus fruit, such as oranges, lemons, limes, and grapefruit; legumes, such as beans, lentils, peas and soybeans; leafy and root vegetables, such as spinach, lettuce, asparagus, cabbages, carrots, onions, and potatoes; oil plants, such as rape, canola, mustard, poppy, olives, sunflowers, coconut, castor oil plants, cocoa beans and groundnuts; marrows, cucumbers, squash and melons; fiber plants, such as cotton, flax, hemp and jute; avocados, cinnamon and camphor; tobacco, nuts, including peanuts, coffee, aubergines, sugar cane, tea, pepper, vines, hops, bananas, alfalfa, and natural rubber plants. Plants most often treated by the method of the present invention include those most vulnerable to the above-noted viruses, in particular, peanut, tobacco, tomato, barley, and bell pepper. The method of the present invention is particularly suitable for reducing the incidence of TSWV in peanuts.

As noted, the composition may be applied in furrow during planting of seeds or seedlings, and/or it may be applied over the plant at or near emergence of the plant, and/or it may be applied during transplanting of established plants; i. e., plants having at least two mature leaves. The fungicide is typically applied in an amount of 100 to 300 g/hectare. In particular embodiments of the present invention, the fungicide is applied in an amount of 200 g/hectare. Suitable fungicides within the scope of the present invention include those identified in the Fungicide Resistance Action Committee (“FRAC”) Code List (Last Update December 2006) which is hereby incorporated herein in its entirety by reference. Particularly preferred fungicides include triazoles. Particularly preferred triazoles include but are not limited to azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, Tebuconazole, tetraconazole, triadimefon, triadimenol, triticonazole and combinations thereof. Prothioconazole is particularly preferred. Other fungicides that may be included within the scope of the present invention include but are not limited to 2-phenylphenol; 8-hydroxyquinoline sulfate; acibenzolar-S-methyl; aldimorph; amidoflumet; ampropylfos; ampropylfos-potassium; andoprim; anilazine; azaconazole; azoxystrobin; benalaxyl; benodanil; benomyl; benthiavalicarb-isopropyl; benzamacril; benzamacril-isobutyl; bilanafos; binapacryl; biphenyl; bitertanol; blasticidin-s; bromuconazole; bupirimate; buthiobate; butylamine; calcium polysulfide; capsimycin; captafol; captan; carbendazim; carboxin; carpropamid; carvone; chinomethionate; chlobenthiazone; chlorfenazole; chloroneb; chlorothalonil; chlozolinate; clozylacon; cyazofamide; cyflufenamide; cymoxanil; cyproconazole; cyprodinil; cyprofuram; Dagger G; debacarb; dichlofluanid; dichlone; dichlorophen; diclocymet; diclomezine; dicloran; diethofencarb; difenoconazole; diflumetorim; dimethirimol; dimethomorph; dimoxystrobin; diniconazole; diniconazole-m; dinocap; diphenylamine; dipyrithione; ditalimfos; dithianon; dodine; drazoxolon; edifenphos; epoxiconazole; ethaboxam; ethirimol; etridiazole; famoxadone; fenamidone; fenapanil; fenarimol; fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; fluquinconazole; flurprimidol; flusilazole; flusulfamide; flutolanil; flutriafol; folpet; fosetyl-al; fosetyl-sodium; fuberidazole; furalaxyl; furametpyr; furcarbanil; furmecyclox; guazatine; hexachlorobenzene; hexaconazole; hymexazol; imazalil; imibencronazole; iminoctadine triacetate; iminoctadine tris(albesilate); iodocarb; ipconazole; iprobenfos; iprodione; iprovalicarb; irumamycin; isoprothiolane; isovaledione; kasugamycin; kresoximmethyl; mancozeb; maneb; meferimzone; mepanipyrim; mepronil; metalaxyl; metalaxyl-m; metconazole; methasulfocarb; methfuroxam; metiram; metominostrobin; metsulfovax; mildiomycin; myclobutanil; myclozolin; natamycin; nicobifen; nitrothal-isopropyl; noviflumuron; nuarimol; ofurace; orysastrobin; oxadixyl; oxolinic acid; oxpoconazole; oxycarboxin; oxyfenthiin; paclobutrazol; pefurazoate; penconazole; pencycuron; phosdiphen; phthalide; picoxystrobin; piperalin; polyoxins; polyoxorim; probenazole; prochloraz; procymidone; propamocarb; propanosine-sodium; propiconazole; propineb; proquinazid; pyraclostrobin; pyrazophos; pyrifenox; pyrimethanil; pyroquilon; pyroxyfur; pyrrolnitrine; quinconazole; quinoxyfen; quintozene; simeconazole; spiroxamine; sulfur; tebuconazole; tecloftalam; tecnazene; tetcyclacis; tetraconazole; thiabendazole; thicyofen; thifluzamide; thiophanate-methyl; thiram; tioxymid; tolclofos-methyl; tolylfluanid; triadimefon; triadimenol; triazbutil; triazoxide; tricyclamide; tricyclazole; tridemorph; trifloxystrobin; triflumizole; triforine; triticonazole; uniconazole; validamycin a; vinclozolin; zineb; ziram; zoxamide; (2S)-N-[2-[4-[[3-(4-chlorophenyl)-2-propinyl]oxy]-3-methoxyphenyl]ethyl]-3-methyl-2-[(methylsulfonyl)amino]-butanamide; 1-(1-naphthalenyl)-1H-pyrrol-2,5-dione; 2,3,5,6-tetrachloro-4-(methylsulfonyl)-pyridine; 2-amino-4-methyl-n-phenyl-5-thiazolcarboxamide; 2-chloro-N-(2,3-dihydro-1,1,3-trimethyl-1H-inden-4-yl)-3-pyridincarboxami-de; 3,4,5-trichloro-2,6-pyridindicarbonitrile; actinovate; cis-1-(4-chlorophenyl)-2-(1H-1,2,4triazol-1-yl)-cycloheptanol; methyl-1-(2,3-dihydro-2,2-dimethyl-1H-inden-1-yl)-1-Himidazol-5-carboxyla-te; mono-potassium carbonate; n-(6-methoxy-3-pyridinyl)-cyclopropancarboxamide; n-butyl-8-(1,1-dimethylethyl)-1-oxaspiro[4.5]decan-3-amine; sodium trathiocarbonate; and copper salts and preparations, such as: Bordeaux mixture, copper hydroxide, copper naphthenate, copper oxychloride, copper sulphate, cufraneb, copper oxide, mancopper, oxine-copper, and combinations thereof.

In certain embodiments of the present invention, the primary treatment composition further comprises one or more additional ingredients including but not limited to one or more safeners and/or pesticides, herbicides and/or additional fungicides. Pesticides include but are not limited to insecticides, acaracides, nematacides and combinations thereof. In particular, acibenzolar-S-methyl, phorate, aldicarb, chlorothalonil, acephate, tebuconazole, and/or neonicotinoids such as imidacloprid, thiacloprid, acetamiprid, clothianidin, nitenpyram, and thiamethoxam are suitable for use as additional ingredients in the primary treatment composition. Each of these is available commercially and may be used in the method of the present invention in amounts conventionally recommended for their intended use. In addition to the foregoing, the primary treatment composition may include other components including but not limited to dyes, extenders, surfactants, defoamers and combinations thereof.

In certain embodiments of the present invention, the method further comprises a step of applying a secondary treatment composition one or more times to foliage and/or roots of plants during plant growth, subsequent to the step of applying the primary treatment composition in-furrow during planting or transplanting.

The secondary treatment composition typically comprises an effective amount of a fungicide, which fungicide may be selected from the same fungicides listed above in connection with the description of the primary treatment composition. Here again, in the secondary treatment composition, prothioconazole is a preferred fungicide. Here as well, the secondary treatment composition can include one or more additional ingredients including but not limited to safeners, pesticides, herbicides, additional fungicides and combinations thereof. Pesticides can include but are not limited to one or more of insecticides, acaracides, nematacides, and combinations thereof. Particular mention is made of one or more of the neonicotinoids as disclosed above, aldicarb, phorate, acephate, acibenzolar-S-methyl, chlorothalonil, tebuconazole, and/or any other known pesticides as used in the art. In addition to the foregoing, the secondary treatment composition may include other components including but not limited to dyes, extenders, surfactants, defoamers and combinations thereof. The secondary treatment composition may be the same or different for each application and may be only foliar applications, only root applications, or combinations of both. For example, the secondary treatment composition may comprise prothioconazole applied to foliage one or more times over the growth cycle, in an amount of 100 to 300 g/hectare, often 200 g/hectare, per application. In an alternative example, the secondary treatment composition may comprise prothioconazole and imidacloprid applied to roots as a drench one or more times over the growth cycle, in an amount of 0.005 to 0.01 g prothioconazole/plant and 0.005 to 0.015 g imidacloprid/plant, more specifically 0.0084 g prothioconazole/plant and 0.01 g imidacloprid/plant, per application. In another example, the secondary treatment composition may comprise prothioconazole applied to foliage one time over the growth cycle, in an amount of 200 g/hectare, followed by a mixture of prothioconazole and imidacloprid applied to roots as a drench two times over the growth cycle.

In certain embodiments of the present invention, the method further comprises a step of applying a preliminary treatment composition to seeds prior to the step of applying the primary treatment composition in-furrow during planting or transplanting. The preliminary treatment composition may comprise an effective amount of one or more of the fungicides identified above in connection with the primary treatment composition, with, here again, prothioconazole being preferred. The preliminary treatment composition may again include additional ingredients including but not limited to one or more safeners, and/or pesticides, herbicides and/or additional fungicides. Pesticides here again include but are not limited to insecticides, acaracides, nematacides and combinations thereof. Here again, as may be particularly mentioned are one or more neonicotinoids mentioned above, aldicarb, phorate, acephate, acibenzolar-S-methyl, chlorothalonil, tebuconazole, and/or any other conventional seed treatments known to those skilled in the art. For example, the preliminary treatment composition may comprise prothioconazole, which is typically used in an amount of 5 to 15 g prothioconazole/100 kg seed, often 10 g prothioconazole/100 kg seed. In addition to the foregoing, the preliminary treatment composition may include other components including but not limited to dyes, extenders, surfactants, defoamers and combinations thereof. Further, if the preliminary treatment composition is applied as a seed coating, it may include other known components such as adhesives. Adhesives which may be mentioned are organic and/or inorganic adhesives including tackifiers.

Each of the treatment compositions used in the method of the present invention may independently be provided in common forms known in the art, for example as emulsifiable concentrates, suspension concentrates, directly sprayable or dilutable solutions, coatable pastes, dilute emulsions, wettable powders, soluble powders, dispersible powders, dusts, granules or capsules. They may each optionally include auxiliary agents commonly used in agricultural treatment formulations and known to those skilled in the art. Examples include but are not limited to wetting agents, dispersants, emulsifiers, penetrants, preservatives, antifreezes and evaporation inhibitors such as glycerol and ethylene or propylene glycol, sorbitol, sodium lactate, fillers, carriers, colorants including pigments and/or dyes, pH modifiers (buffers, acids, and bases), salts such as calcium, magnesium, ammonium, potassium, sodium, and/or iron chlorides, fertilizers such as ammonium sulfate and ammonium nitrate, urea, and defoamers.

Suitable defoamers include all customary defoamers including silicone-based and those based upon perfluoroalkyl phosphinic and phosphonic acids, in particular silicone-based defoamers, such as silicone oils, for example.

Defoamers most commonly used are those from the group of linear polydimethylsiloxanes having an average dynamic viscosity, measured at 25° C., in the range from 1000 to 8000 mPas (mPas=millipascal-second), usually 1200 to 6000 mPas, and containing silica. Silica includes polysilicic acids, meta-silicic acid, ortho-silicic acid, silica gel, silicic acid gels, kieselguhr, precipitated SiO₂, and the like.

Defoamers from the group of linear polydimethylsiloxanes contain as their chemical backbone a compound of the formula HO—[Si(CH₃)₂—O—]ₙ—H, in which the end groups are modified, by etherification for example, or are attached to the groups —Si(CH₃)₃. Non-limiting examples of defoamers of this kind are RHODORSIL® Antifoam 416 (Rhodia) and RHODORSIL® Antifoam 481 (Rhodia). Other suitable defoamers are RHODORSIL® 1824, ANTIMUSSOL 4459-2 (Clariant), Defoamer V 4459 (Clariant), SE Visk and AS EM SE 39 (Wacker). The silicone oils can also be used in the form of emulsions.

The present invention will further be described by reference to the following examples. The examples are merely illustrative of the invention and are not intended to be limiting. Unless otherwise indicated, all parts are by weight.

### EXAMPLES

The following examples (1 to 8) illustrate the treatment of plants using the method of the present invention, demonstrating combinations of treatment compositions and application steps and their combined effects on plant growth.

### Examples 1, 2, and 3

Cultivation—Three replicated field trials were conducted at the Bayer CropScience research farm in Tifton, Ga., using standard commercial peanut practices. Prior to planting, fields were flag staked to establish 8 replications per treatment per trial of two rows by 30 ft long (6 ft by 30 ft, 60 row feet total) each. On May 19, two cultivars of peanut (Arachis hypogaea L.), Georgia Green (two fields, Examples 1 and 2) and Carver (one field, Example 3) were planted using a two-row Monosem air planter. During the planting passes a tractor mounted compressed air system was used to spray the in-furrow treatment into the furrow before row closure. All other plots were not treated at planting. Single field passes were used to plant entire fields to ensure a uniform planting depth.

Treatments—
Treated—Plots received an in-furrow application of prothioconazole at planting at a rate of 200 g prothioconazole/Ha. Through the season these plots received foliar fungicide maintenance using standard commercial fungicides including chlorothalonil and tebuconazole.
Untreated—Due to standard practices in peanut pesticide testing, each treated plot always included untreated peanut plots adjacent to the treated plots that serve as spacer rows. Untreated plots did not receive an in-furrow application of prothioconazole. Untreated plots in Examples 1 and 3 received foliar maintenance applications to control foliar diseases. Untreated plots in Example 2 did not receive any foliar maintenance.

TSWV rating—Plots were examined periodically following emergence for differences in appearance. In certain instances, (August 19 data for example), TSWV incidence is determined as the number of row feet with TSWV symptoms (chlorosis and stunting) which was determined for the two treatments.

### Example 4

Cultivation—A non-replicated GLP (good laboratory practice) peanut residue trial was in progress at the Tifton, Ga., location using similar cultivation methods as in Examples 1-3. The planting and in-furrow treatment date was May 26. Prothioconazole treated seed were prepared two weeks prior on May 12. Plots were 525 row ft.

Treatments—
Untreated—no in-furrow treatment, chlorothalonil maintenance only for foliar diseases.
Seed treatment, in-furrow, and foliar—prothioconazole seed treatment@10 g active ingredient/100 kg seed plus prothioconazole applied in-furrow@200 g active ingredient/Ha followed by prothioconazole@100 g active ingredient/Ha on July 21, August 4, and August 18.
Foliar only—prothioconazole@200 g active ingredient/Ha on July 21, August 4, and August 18.

TSWV rating—For TSWV incidence determination, on August 22 the number of row feet per plot with TSWV symptoms (chlorosis and stunting) was determined for the three treatments. Statistics cannot be run on single-replication trials.

### Example 5

Cultivation—A non-replicated GLP peanut residue trial was conducted in Molino, Fla., using similar methods as in Examples 3 and 4. The cultivar used was Georgia Green. Prothioconazole treated seed were prepared on May 12. Plots were 160 row ft. in length.

Treatments—
Untreated—no in-furrow treatment, chlorothalonil maintenance only for foliar diseases.
Seed treatment, in-furrow, and foliar—prothioconazole seed treatment@10 g active ingredient/100 kg seed plus prothioconazole applied in-furrow@200 g active ingredient/Ha followed by a program of three chlorothalonil applications and four applications of prothioconazole@100 g active ingredient/Ha.
Foliar only—A program of three chlorothalonil applications and four applications of prothioconazole@200 g active ingredient/Ha.

TSWV rating—For TSWV incidence determination, on August 23 the number of row feet per plot with TSWV symptoms (chlorosis and stunting) was determined for the three treatments. Statistics cannot be run on single replication trials.

### Example 6

Cultivation—A replicated trial on tomato (Lycopersicon esculentum MILL.) was initiated in Molino, Fla. to determine if drenches of prothioconazole alone and in combination with the insecticide imidacloprid would suppress TSWV in tomato. Tomato plants, cultivar FL 47 were transplanted on April 11 into 4 rows, each 9.1 meters long, 60 plants per plot, with three replications. Treatments were applied, into a shallow bowl dug at the base of each plant, as a drench in 40 ml water per plant (6 days after transplanting) on April 17.

Treatments—
Untreated—no in-furrow treatment
Imidacloprid@0.01 g imidacloprid/plant.
Prothioconazole—prothioconazole@0.0084 g active ingredient/plant.
Prothioconazole+Imidacloprid—prothioconazole@0.0084 g active ingredient/plant+imidacloprid@0.01 g imidacloprid/plant.

TSWV rating—University researchers recommend buffers in TSWV testing. Therefore, the center two rows (30 plants) per plot were used for virus ratings with the outer two rows acting as buffers. TSWV incidence determinations were made based on the presence or absence of TSWV symptoms (chlorosis and stunting) per plant. The four treatments were rated at 21, 29, and 39 days after treatment.

Synergy formula—The Colby formula for proof of synergy was used in Example 6. The percent incidence values were converted to percent control with Abbotts's formula (1-treated/untreated)*100. Percent control values for solo treatment X and solo treatment Y, were entered into the Colby formula. When the value determined from the plots with both treatment X and Y applied together is greater than the value determined by the Colby formula then synergy is indicated. The formula is: X+Y−(X*Y/100).

### Example 7

Cultivation—A trial on bell pepper (Capsicum annum L.) was initiated in Molino, Fla. to see if drenches of prothioconazole alone and in combination with the insecticide imidacloprid could control TSWV in pepper. Bell pepper plants were transplanted on April 11 into 9.1 meter plots with three replications as in Example 6. Treatments were applied as a drench in 40 ml water per plant (7 days after transplanting) on April 18 as in Example 6.

Treatments—
Untreated—no in-furrow treatment.
Imidacloprid—imidacloprid@0.01 g imidacloprid/plant.
Prothioconazole—prothioconazole@0.0084 g prothioconazole/plant.
Prothioconazole+Imidacloprid—prothioconazole@0.0084 g active ingredient/plant+imidacloprid@0.01 g imidacloprid/plant.

TSWV rating—For TSWV incidence determination, the percentage of plants with TSWV symptoms (chlorosis and stunting) was determined for the four treatments at 21, 29, 38, and 47 days after treatment as in Example 6.

Synergy formula—The Colby formula for proof of synergy was used in Example 7 as in Example 6.

### Example 8

Cultivation—A trial on tobacco (Nicotiana tabacum) was initiated in Molino, Fla., to see if drenches of prothioconazole alone and in combination with the insecticide imidacloprid could control TSWV in tobacco. Plants of cultivar C-371 Gold were transplanted on April 28 into 9.1 meter plots with three replications. All eight treatments were applied after transplanting on May 1. Foliar treatments were applied as a broadcast spray, while drenches were applied as in Example 6. Acibenzolar-S-methyl is a plant defense activator used to control TSWV in tobacco.

Treatments—
Untreated
Imidacloprid@0.01 g imidacloprid/plant
Imidacloprid@0.015 g Imidacloprid/plant
Prothioconazole@0.0084 g active ingredient/plant
Prothioconazole@0.0084 g active ingredient/plant+Imidacloprid@0.01 g imidacloprid/plant
Prothioconazole@0.0084 g active ingredient/plant+Imidacloprid@0.015 g imidacloprid/plant
Prothioconazole@0.0084 g active ingredient/plant+Imidacloprid@0.015 g imidacloprid/plant followed the same day by acibenzolar-S-methyl@2.47 g active ingredient/Ha as a broadcast spray as per label.
Acibenzolar-S-methyl@2.47 g active ingredient/Ha as a broadcast spray as per label.

TSWV rating—For TSWV incidence determination the percentage of plants with TSWV symptoms (chlorosis and stunting) was determined for the eight treatments as in Example 6.

### Results:

### Examples 1, 2, and 3

No differences in plant appearance or stand were obvious following emergence in any trial. TSWV incidence measured in percent of row feet with symptoms were significantly lower in the prothioconazole treated plots of Georgia Green (Example 1 and 2) that received the in-furrow treatment compared to both of the untreated controls. In the Carver trial (Example 3) the reduction was not significant. Treated plots were thick with uniform plant growth. Untreated plots had gaps where plants are either stunted or dead from TSWV. The following data were obtained for the three trials (Table 1).

TABLE 1
TSWV Incidence (number of symptomatic feet of row per 60 foot plot)

| | Prothioconazole in- | |
|---|---|---|
| | furrow with foliar | Adjacent untreated plot |
| | maintenance | with foliar maintenance |
| Example 1: | 12 | 19 |
| Georgia Green | 20 | 15 |
| | 18 | 28 |
| | 14 | 22 |
| | 19 | 27 |
| | 18 | 28 |
| | 8 | 20 |
| | 19 | 23 |
| | Prothioconazole in- | Adjacent untreated plot |
| | furrow with foliar | with no foliar |
| | maintenance | maintenance |
| Example 2: | 13 | 29 |
| Georgia Green | 25 | 35 |
| | 24 | 40 |
| | 17 | 32 |
| | 18 | 28 |
| | 25 | 29 |
| | 27 | 26 |
| | 20 | 27 |
| | Prothioconazole in- | |
| | furrow with foliar | Adjacent untreated plot |
| | maintenance | with foliar maintenance |
| Example 3: | 17 | 13 |
| Carver | 8 | 13 |
| | 19 | 29 |
| | 26 | 26 |
| | 12 | 16 |
| | 16 | 24 |
| | 7 | 10 |
| | 9 | 7 |

### Example 4

The number of row feet infected with TSWV was numerically lower for the plots receiving the seed treatment, in-furrow, and foliar applications compared with either the foliar only program or the untreated. (Table 2).

TABLE 2
TSWV Incidence (number of symptomatic feet of row)
in a peanut GLP Trial

| | Percent row feet infected |
|---|---|
| | with TSWV |
| Untreated | 38.8% |
| Seed treatment, in-furrow, | 24.0% |
| Foliar program | |
| Foliar prothioconazole only | 30.5% |

### Example 5

The number of row feet infected with TSWV was numerically lower for the plots receiving the seed treatment, in-furrow, and foliar prothioconazole applications (treatment 2) compared with either the foliar only program (treatment 3) or the chlorothalonil maintenance only (treatment 1). (Table 3)

TABLE 3
TSWV Incidence (number of symptomatic feet of row)
in a peanut GLP Trial

| | Percent row feet |
|---|---|
| | infected with TSWV |
| Untreated | 16.8% |
| Seed treatment, in- | 10.6% |
| furrow, Foliar program | |
| Foliar prothioconazole | 16.25% |
| only | |

### Example 6

TSWV pressure was described as unusually severe in this tomato trial. All treatments including prothioconazole reduced TSWV (Table 4) compared to the untreated controls. Solo prothioconazole was similar to the standard Imidacloprid. The 39-day data indicate an additive or synergistic effect with prothioconazole and Imidacloprid (Table 4b).

TABLE 4
Percent incidence of TSWV in tomatoes

| | 21 days | 29 days | 39 days |
|---|---|---|---|
| | after | after | after |
| | treatment | treatment | treatment |
| Untreated | 29.2 | 67.5 | 84.5 |
| Imidacloprid @ 0.01 g | 10.2 | 33.4 | 49.6 |
| imidacloprid/plant | | | |
| prothioconazole @ 0.0084 g active | 13.2 | 48.6 | 66.6 |
| ingredient/plant | | | |
| prothioconazole @ 0.0084 g active | 10.3 | 26.6 | 38.6 |
| ingredient/plant + | | | |
| imidacloprid @ 0.01 g | | | |
| imidacloprid/plant | | | |

TABLE 4b
Percent control and Colby synergy value for incidence of TSWV
in tomatoes

| | 21 days | 29 days | 39 days |
|---|---|---|---|
| | after | after | after |
| | treatment | treatment | treatment |
| Untreated | | | |
| Imidacloprid @ 0.01 g | 65.07 | 50.52 | 41.30 |
| imidacloprid/plant | | | |
| prothioconazole @ 0.0084 g active | 54.79 | 28.00 | 21.18 |
| ingredient/plant | | | |
| prothioconazole @ 0.0084 g active | 64.73 | 60.59 | 54.32 |
| ingredient/plant + Imidacloprid | | | |
| @ 0.01 g imidacloprid/plant | | | |
| Colby formula value | 84.21 | 64.37 | 53.74 |
| Synergism (super additive effect) | No | No | Synergy |
| | Synergy | Synergy | |

### Example 7

TSWV pressure was described as moderate in this bell pepper trial. All treatments including solo prothioconazole reduced TSWV (Table 5) compared to the untreated controls. TSWV level increased by 1.4 percent in the untreated from 38 days after treatment (“DAT”) to 47 DAT. TSWV increased roughly 4.5 percent in the imidacloprid and prothioconazole treatments from 38 to 47 DAT. However, TSWV increased only 1.7 percent in the combination treatment. Three of the four ratings indicate an additive or synergistic effect with prothioconazole and imidacloprid.

TABLE 5
Percent incidence TSWV in bell peppers

| | 21 days | 29 days | 38 days | 47 days |
|---|---|---|---|---|
| | after | after | after | after |
| | treatment | treatment | treatment | treatment |
| Untreated | 24.1 | 46.9 | 51.4 | 52.8 |
| Imidacloprid @ 0.01 g | 17.8 | 25.4 | 38.3 | 42.6 |
| imidacloprid/plant | | | | |
| Prothioconazole @ | 18.1 | 31.8 | 44.8 | 49.4 |
| 0.0084 g active | | | | |
| ingredient/plant | | | | |
| Prothioconazole @ | 13.1 | 19.6 | 27.0 | 28.7 |
| 0.0084 g active | | | | |
| ingredient/plant + | | | | |
| Imidacloprid @ 0.01 g | | | | |
| imidacloprid/plant | | | | |

TABLE 5b
Percent control and Colby synergy value for incidence of TSWV
in bell peppers

| | 21 days | 29 days | 38 days | 47 days |
|---|---|---|---|---|
| | after | after | after | after |
| | treatment | treatment | treatment | treatment |
| Untreated | — | — | — | — |
| Imidacloprid @ 0.01 g | 26.14 | 45.84 | 25.49 | 19.32 |
| imidacloprid/plant | | | | |
| Prothioconazole @ | 24.90 | 32.20 | 12.84 | 6.44 |
| 0.0084 g active | | | | |
| ingredient/plant | | | | |
| Prothioconazole @ | 45.64 | 58.21 | 47.47 | 45.64 |
| 0.0084 g active | | | | |
| ingredient/plant + | | | | |
| Imidacloprid | | | | |
| @ 0.01 g | | | | |
| imidacloprid/plant | | | | |
| Colby formula value | 44.53 | 63.28 | 35.05 | 24.51 |
| Synergism | Synergy | No Synergy | Synergy | Synergy |
| (superadditive effect) | | | | |

### Example 8

TSWV pressure was described as moderate in this Tobacco trial. All treatments including solo prothioconazole reduced TSWV (Table 6) compared to the untreated controls. Synergy was not indicated in the tobacco trial.

TABLE 6
Percent incidence TSWV in tobacco

| | 14 days | 21 days | 38 days |
|---|---|---|---|
| | after | after | after |
| | treatment | treatment | treatment |
| Untreated | 43.4 | 47.2 | 68.9 |
| Imidacloprid @ 0.01 g | 23.9 | 24.4 | 45.0 |
| imidacloprid/plant | | | |
| Imidacloprid @ 0.015 g | 23.9 | 25.5 | 45.5 |
| imidacloprid/plant | | | |
| Prothioconazole @ | 32.2 | 35.0 | 56.7 |
| 0.0084 g active | | | |
| ingredient/plant | | | |
| Prothioconazole @ | 21.1 | 25.0 | 46.1 |
| 0.0084 g active | | | |
| ingredient/plant + | | | |
| Imidacloprid | | | |
| @ 0.01 g | | | |
| imidacloprid/plant | | | |
| Prothioconazole @ | 29.4 | 10.6 | 51.1 |
| 0.0084 g active | | | |
| ingredient/plant + | | | |
| Imidacloprid | | | |
| @ 0.015 g | | | |
| imidacloprid/plant | | | |
| Prothioconazole @ | 24.5 | 25.0 | 45.0 |
| 0.0084 g active | | | |
| ingredient/plant + | | | |
| Imidacloprid | | | |
| @ 0.015 g | | | |
| imidacloprid/plant followed | | | |
| the same day by | | | |
| acibenzolar-S-methyl@ | | | |
| 2.47 g ai/Ha | | | |
| as a broadcast spray | | | |
| per label. | | | |
| acibenzolar-S-methyl @ | 36.7 | 46.7 | 53.9 |
| 2.47 g active | | | |
| ingredient/Ha as | | | |
| a broadcast spray | | | |
| per label. | | | |

The efficacy of the method of the present invention in reducing the incidence of insect-vectored viral infections was unexpected because fungicides, and in fact any agricultural chemicals, are not known to reduce the incidence or severity of viral infections such as TSWV.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of improving the growth of a plant by reducing the incidence of one or more insect-vectored viral infections, comprising the step of applying a primary treatment composition in-furrow during planting of a seed or seedling or during transplanting of the plant, wherein the primary treatment composition comprises an effective amount of a fungicide.

2. The method of claim 1, wherein the plant comprises peanut, tobacco, tomato, barley, or bell pepper.

3. The method of claim 1, wherein the viral infection comprises one or more viruses vectored by whitefly, aphid, leafhopper, and/or thrips.

4. The method of claim 3, wherein the viral infection comprises tomato spotted wilt virus, tomato yellow leaf curl virus, and/or barley yellow dwarf virus.

5. The method of claim 1, wherein the primary treatment composition further comprises safeners, pesticides, herbicides, and/or additional fungicides.

6. The method of claim 5 wherein the primary treatment composition further comprises pesticides, which are selected from the group consisting of insecticides, acaracides, nematacides and combinations thereof.

7. The method of claim 6 where the primary treatment composition further comprises imidacloprid, thiacloprid, acetamiprid, clothianidin, nitenpyram, thiamethoxame, acibenzolar-S-methyl, phorate, aldicarb, chlorothalonil, acephate, and/or tebuconazole.

8. The method of claim 5 wherein the primary treatment composition further comprises dyes, extenders, surfactants, and/or defoamers.

9. The method of claim 1, wherein the fungicide comprises prothioconazole, which is applied in an amount of 100 to 300 g/hectare.

10. The method of claim 9, wherein the prothioconazole is applied in an amount of 200 g/hectare.

11. The method of claim 1, further comprising the step of applying a secondary treatment composition comprising a fungicide one or more times to foliage and/or roots of plants during plant growth, subsequent to the step of applying the primary treatment composition in-furrow during planting or transplanting.

12. The method of claim 11 wherein the secondary treatment composition further comprises safeners, pesticides, herbicides, and/or additional fungicides.

13. The method of claim 12 wherein the secondary treatment composition further comprises pesticides, which are selected from the group consisting of insecticides, acaracides, nematacides and combinations thereof.

14. The method of claim 12 wherein the secondary treatment composition further comprises imidacloprid, thiacloprid, acetamiprid, clothianidin, nitenpyram, thiamethoxame, acibenzolar-S-methyl, phorate, aldicarb, chlorothalonil, acephate, and/or tebuconazole.

15. The method of claim 12 wherein the secondary treatment composition further comprises dyes, extenders, surfactants, and/or defoamers.

16. The method of claim 15, wherein the secondary treatment composition is applied to foliage.

17. The method of claim 16, wherein the secondary treatment composition comprises prothioconazole and is applied in an amount of 100 to 300 g prothioconazole/hectare.

18. The method of claim 11, wherein the secondary treatment composition is applied to roots as a drench.

19. The method of claim 18, wherein the secondary treatment composition comprises prothioconazole and imidacloprid and is applied in an amount of 0.005 to 0.01 g prothioconazole/plant and 0.005 to 0.015 g imidacloprid/plant.

20. The method of claim 1, further comprising the step of applying a preliminary treatment composition comprising a fungicide to seeds prior to the step of applying the primary treatment composition in-furrow during planting or transplanting.

21. The method of claim 20, wherein the preliminary treatment composition further comprises one or more additional ingredients selected from the group consisting of safeners, pesticides, herbicides and additional fungicides.

22. The method of claim 21 wherein the additional ingredients comprise pesticides, which are selected from the group consisting of insecticides, acaracides, nematacides and combinations thereof.

23. The method of claim 22 wherein the additional ingredients comprise imidacloprid, thiacloprid, acetamiprid, clothianidin, nitenpyram, thiamethoxame, acibenzolar-S-methyl, phorate, aldicarb, chlorothalonil, acephate, and/or tebuconazole.

24. The method of claim 23 wherein the preliminary treatment composition further comprises dyes, extenders, surfactants, and/or defoamers.

25. The method of claim 20, wherein the preliminary treatment composition comprises prothioconazole and is applied in an amount of 5 to 15 g prothioconazole/100 kg seed.

26. The method of claim 1, 11 or 20 wherein said fungicide comprises one or more triazoles.

27. The method of claim 26 wherein said triazole is selected from the group consisting of azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, triticonazole and combinations thereof.

28. The method of claim 27 wherein said fungicide is prothioconazole.
